(19) United States
(12) Patent Application Publication
(10) Pub. No.: US 2011/0151088 A1
(43) Pub. Date: Jun. 23, 2011

(54) HEAT FLUX FREEZER CONTROL APPARATUS AND METHOD

(76) Inventor: Michael D. NEWMAN, Hillsborough, NJ (US)

(21) Appl. No.: 12/644,135

(22) Filed: Dec. 22, 2009

(51) Int. Cl. A23L 3/36; F17C 7/02

(52) U.S. Cl. 426/524; 99/475; 99/477; 62/52.1

(57) ABSTRACT

Apparatus and method embodiments for reducing the temperature of a product include a housing having a chamber therein, and an inlet and an outlet in communication with the chamber; a plurality of zones in the chamber between the inlet and the outlet and arranged in descending order of heat transfer rate atmospheres for the product from the inlet to the outlet; and a conveyor assembly for transferring the product from the inlet through the plurality of zones to the outlet.

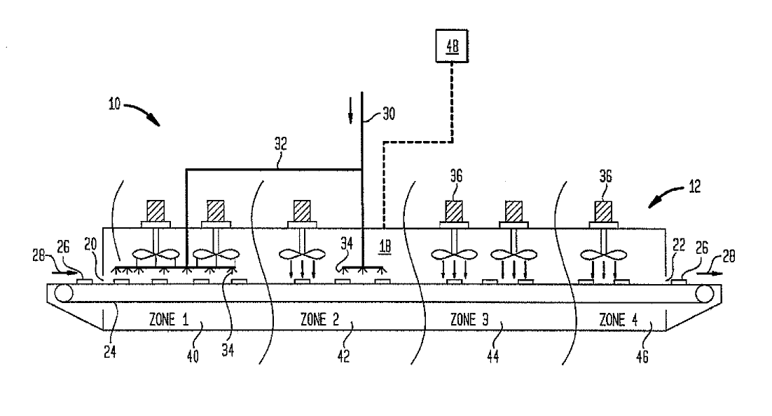

The present embodiments relate to freezing systems, especially freezing systems for food products.

When a product is frozen, such as a food product, and such as with liquid nitrogen, there exists large temperature differences between the product and an operating temperature of the freezing system employed to freeze the product. These large temperature differentials are ideal for freezing a product quickly. A highly convective environment can then be utilized to accelerate the freezing process. In addition, cryogen can be sprayed directly onto the product for an even more aggressive evaporative surface heat transfer at the product.

As the food product enters a cryogenic freezing process, the food product being at a warmer temperature than the freezing system, the product will immediately start transferring heat to its surroundings as it undergoes freezing. The faster the heat is transferred from the product, the quicker the product will freeze. However, there are certain physical limitations that come into effect as the product transfers heat to its surrounding environment. First, the product can only transfer heat from its surface. Therefore, surface heat is removed initially very quickly as the product is frozen. Second, the amount of cooling applied to the surface in terms of convection, conduction or evaporative cooling impacts the rate at which heat can be further removed from the surface. Therefore, early in the freezing process it is beneficial to have maximum surface heat transfer.

As the product continues to freeze and its surface gets colder, the rate at which heat can physically be removed from the product decreases. This is because the internal heat from the product must now travel to the product's surface by way of conduction, ultimately warming the outer surface from which heat is being removed. The rate at which the product can transfer heat to the surface is limited by its composition and physical properties. The rate of heat removal or heat flux (W/m²) is an exponentially decaying process with time.

Accordingly, there are two factors which impact the freezing process. The first factor is the actual state of the product which will give up heat. The second factor is the means or type of cooling applied to the product surface to remove this heat.

In known freezing processes, the applied surface heat transfer coefficient is constant throughout the freezing process. In some situations, liquid nitrogen may be applied directly to the product surface either upon entering or exiting the freezing process, but this is the extent of variability.

The process of applying a high heat transfer coefficient to the surface of the product is typically achieved by means of convection. That is, gas can be pressurized, usually by internal fans of the freezing system, and the gas velocity increased for this high velocity gas to be brought into contact with the food product surface. In order to achieve these high gas velocities, power must be used to drive the fans. Power and velocity are directly proportional, i.e. higher velocities equal more power. The benefit of higher velocities is higher surface heat transfer as discussed above, while the disadvantage of the higher velocity is a decrease in overall freezing efficiency. The overall freezing efficiency is decreased because some of the energy transferred to the gas for the purpose of accelerating it, also takes the form of heat. This heat energy decreases the overall effective cooling capacity of the system.

Freezer apparatus and method embodiments are provided, wherein the rate at which a product, such as a food product, gives up or loses its heat is equal to the rate at which a convective environment removes the heat from the product surface. Therefore, it is not necessary to use additional energy for freezing of the food product.

For a more complete understanding of the present embodiments, reference may be made to the following description of the heat flux freezer control apparatus and method, and particular embodiments thereof, in conjunction with the following drawing, of which:

The FIGURE shows the heat flux control system apparatus, including method, of the present embodiments.

In such an apparatus, steps are employed to insure that energy is not used unnecessarily. That is, the product is analyzed prior to freezing the product, and such analyzing step characterizes and quantifies product dimensions, composition, moisture content, and a temperature of the product prior to entering the freezing apparatus. A control system for the apparatus is programmed with these parameters. The control system is also programmed for a given production rate of the product with respect to its freezing. Accordingly, the apparatus would then optimize the freezing process in view of the parameters discussed above and the given production rate for such product.

A high heat transfer process would be applied at the initial stage of the freezing and thereafter heat transfer would diminish as the product freezes. The convective transfer environment and/or the conductive heat transfer environment, by convection fans and/or cryogen spray assemblies, respectively, are in communication with the control system such that the fans and cryogen spray can be automatically adjusted throughout the production as the incoming product temperatures, production rates or products themselves change. The residence time of the product during exposure to the heat transfer environment or atmospheres is also controlled, as is discuss below. The apparatus and process can be retrofitted to existing freezing systems.

A heat flux freezer control apparatus is shown in the FIGURE generally at 10. The apparatus 10 includes a housing 12 or enclosure having an inlet 20 and an outlet 22. A freezing chamber 18 is provided at an interior of the housing 12 in communication with the inlet 20 and the outlet 22. The inlet 20 and outlet 22 may be disposed at opposed ends of the housing 12. A conveyor belt 24 moves for operation through the chamber 18. That is, the conveyor belt 24 extends from the inlet 20 through the freezing chamber 18 to the outlet 22 for conveying or transporting products 26, such as for example food products, through the freezing chamber 18. Arrows 28 identify the direction of movement of the conveyor belt 24 with respect to the freezing chamber 18.

A pipe 30 or conduit extends through the housing 12 into the freezing chamber 18 to introduce a cryogen from a remote source (not shown) into the chamber 18. The pipe 30 may be branched at for example 32, the branched portion 32 also extending through the housing 12 into the freezing chamber 18. Each one of the pipes 30, 32 terminate in at least one injection nozzle 34. A cryogen, such as for example carbon dioxide, nitrogen or liquid air, is introduced into the pipes 30, 32 and emitted out of the corresponding ones of the injection nozzles 34 connected to ends of the pipes. Gas moving devices, such as fan assemblies 36, are mounted in the freezing chamber 18 to move and circulate the cryogen emitted from the nozzles 34. The temperature in the freezing chamber is from −250° F. to O′ Fahrenheit (F).

The housing 12 and hence the freezing chamber 18 is provided with a plurality of zones 40, 42, 44, 46 (referred to collectively as “40-46”). The zones 40-46 as shown in the FIGURE are arranged in order of highest heat flux zone 40 (Zone 1) closest to the inlet 20 to the lowest amount of heat flux zone 46 (Zone 4) at the outlet 22.

In operation, a product 26 enters the apparatus 10 and is immediately sprayed with cryogen and subjected to a highly convective environment in zone 40. Zone 40 is the highest heat flux zone in the apparatus 10. The product 26 then travels through the freezing chamber 18 and zones 42-46 (additional zones may be used and other configurations employed) where heat flux is diminished until the product 26 is completely frozen and is discharged from the outlet 22. Based on the thermal characteristics of the product 26 introduced at the inlet 20 and the rate at which it needs to be frozen, the fan assembly 36 speeds and cryogen injection rates will be adjusted to control the desired heat flux curve through the zones 40-46 for the apparatus.

A controller 48 of the apparatus 10 is in communication with the freezing chamber 18 and in particular the conveyor belt 24, injection nozzles 34, fan assemblies 36 and the zones 40-46. Communication can be by sensors or other know measurement devices. The characteristics and physical qualities of the product dimensions, composition, moisture content and temperature of the product 26 prior to same entering the inlet 20 are loaded into the controller 48. Depending upon the production rate of the product and the freezing characteristics that will have to be employed, such will be taken into consideration by the controller 48 to adjust the speed of the conveyor belt 24 and hence the speed of the product 26 through the freezing chamber 18 and/or the residence time of the product 26 in each one of the zones 40-46 of the freezing chamber 18. In addition, the amount of the cryogen being sprayed from the nozzles 34 on to the product 26, as well as the speed of the fans 36 will also be controlled by the controller 48. In effect, the products are subjected to the highest heat flux in the zone 40, i.e. closed to the inlet 20, with the heat flux being reduced as the products 26 are transferred to the subsequent zones 42-46. Such a freezing process calls for a reduction in freezing upon the actual frozen state of the product 26, which thereby optimizes use of the freezing medium, e.g. whether the cryogen spray is used and/or whether instead a convective fan gas flow is used.

The chamber 18 may contain both fan assemblies 36 and cryogenic spray nozzle 34, each of which can be used independently or in conjunction with each other. For example, a combination of the fan assemblies 36 and cryogenic spray nozzles 34 will provide the greatest heat transfer rate of the product 26 and therefore, such an arrangement would first act upon the product as it enters the freezing chamber 18 from the inlet 20. The fan assemblies 36 at the outlet 22 have the lowest heat transfer rate in the chamber 18. Accordingly, zone 40 and zone 46 would each provide the corresponding extremes of highest heat transfer rate and lowest heat transfer rate, respectively. Therebetween, the zones 42, 44 would have decreasing heat transfer rates, respectively. That is, zone 42 would have perhaps fewer fan assemblies 36 and nozzles 34 than zone 40, while zone 44 would have fewer still, perhaps only a pair of fan assemblies 36, than zone 42. The zone 46 would have only one fan assembly 36, for example, as the heat transfer demand is lowest at this point before the outlet 22. Fans 36 alone provide the lowest heat removal or heat flux rate, cryogenic spray alone the next highest heat removal rate, while a combination of fans and cryogenic spray provides the highest heat transfer rate. Therefore, flexibility to vary the heat flux or heat transfer rate in the apparatus 10 can be obtained by the controller 48 employing any combination of fans and nozzles to act upon the product 26.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. An apparatus for reducing the temperature of a product, comprising:
a housing having a chamber therein, and an inlet and an outlet in communication with the chamber;
a plurality of zones in the chamber between the inlet and the outlet, each one of the plurality of zones having a heat transfer rate atmosphere and being arranged in descending order of the heat transfer rate atmospheres from the inlet to the outlet; and
a conveyor assembly for transferring the product from the inlet through the plurality of zones to the outlet.

2. The apparatus of claim 1, wherein an inlet zone of the plurality of zones is located adjacent the inlet of the chamber and comprises the greatest heat transfer rate atmosphere.

3. The apparatus of claim 1, wherein an outlet zone of the plurality of zones is located adjacent the outlet of the chamber and comprises the lowest heat transfer rate atmosphere.

4. The apparatus of claim 1, further comprising heat transfer assemblies disposed in the chamber at the plurality of zones, the heat transfer assemblies selected from at least one of fans, cryogenic spray nozzles or combinations thereof.

5. The apparatus of claim 4, wherein the cryogenic spray nozzles provide a chilling medium selected from at least one of carbon dioxide, nitrogen or liquid air.

6. The apparatus of claim 2, wherein the inlet zone comprises fans and cryogenic spray nozzles.

7. The apparatus of claim 3, wherein the outlet zone comprises at least one fan.

8. The apparatus of claim 4, further comprising a controller in communication with the chamber, the plurality of zones, the heat transfer assemblies, the conveyor assembly and the heat transfer rate atmospheres, the controller having stored therein physical characteristics of the product to adjust the heat transfer rate atmospheres for the product such that heat transfer rate of the product decreases as the product moves from the inlet through each one of the plurality of zones to the outlet.

9. The apparatus of claim 1, wherein the product is a food product.

10. A method for reducing the temperature of a product, comprising:
identifying physical characteristics and a temperature of the product prior to reducing the temperature of the product;
exposing the product to a plurality of heat transfer atmospheres arranged in descending order of heat transfer rates;
sensing the temperature of the product while being exposed to the plurality of heat transfer atmospheres; and
reducing the heat transfer rates responsive to the temperature sensed of the product.

11. The method of claim 10, wherein said physical characteristics are selected from dimensions of the product, composition of the product, and moisture content of the product.

12. The method of the claim 10, wherein at least one of the plurality of heat transfer atmospheres comprises a cryogenic substance.

13. The method of claim 12, wherein the cryogenic substance is at least one of carbon dioxide, nitrogen or liquid air.

14. The method of claim 12, wherein at least one of the plurality of heat transfer atmospheres comprises a fan assembly.

15. The method of claim 10, wherein the step of reducing the heat transfer rates comprises reducing exposure of the product to the heat transfer atmospheres.

16. The method of claim 10, wherein the product is a food product.
